(19) United States
(12) Patent Application Publication
(10) Pub. No.: US 2013/0080353 A1
(43) Pub. Date: Mar. 28, 2013

(54) METHODS AND SYSTEMS OF FINANCIAL DATA ANALYSIS AND SIMULATION

(71) Applicants: Moshe Kovarsky, Rehovot (IL); Ayal Bahary, Moshav Herev LeEt (IL)

(72) Inventors: Moshe Kovarsky, Rehovot (IL); Ayal Bahary, Moshav Herev LeEt (IL)

(73) Assignee: AlphaVee Solutions Ltd., Biyamina (IL)

(21) Appl. No.: 13/603,444

(22) Filed: Sep. 5, 2012

Related U.S. Application Data
(60) Provisional application No. 61/539,720, filed on Sep. 27, 2011.

(51) Int. Cl. G06Q 40/06

(52) U.S. Cl. 705/36 R

(57) ABSTRACT

A method of financial data analysis that comprises calculating for each member of a first group of publically traded financial instruments, a current growth grade according to combination of growth factor scores and a current value grade according to a combination of value factor scores, generating a presentation depicting the distribution of members of the first group according to their growth and value factor scores, receiving from a user a correlation between a range of value grades and a range of growth grades, the correlation being selected according to the presentation, selecting a second group of the publically traded financial instruments according to historical financial data so that each member thereof having historical growth and value grades which correspond with the value and growth grade ranges, performing back testing simulation(s) to members of the second group according to financial data from the past period, and presenting the testing simulation outcome.

### RELATED APPLICATION

This application claims the benefit of priority under 35 USC §119(e) of U.S. Provisional Patent Application No. 61/539,720 filed Sep. 27, 2011, the contents of which are incorporated herein by reference in their entirety.

### FIELD AND BACKGROUND OF THE INVENTION

The present invention, in some embodiments thereof, relates to financial data and, more particularly, but not exclusively, to methods and systems of historical and current financial data analysis.

Each day, the financial trading markets generate enormous amounts of data. Without the proper training or reference, much of this information will look meaningless or chaotic. Examples of such information are price changes that appear to occur for no explainable reason. These are price changes that most Economists' believe are the norm in financial markets.

During the last years, various methods and systems have been developed to harness computational power to provide new means of predicting the behavior of financial instrument, such as the performance of publically traded stocks. For example, US Patent application No. 2007/0156479 teaches software, methods and system that creates an interactive, auto-execution financial trading platform with unique forecasting algorithms, trading graphs and data mining features. This platform uses a univariate and multivariate architecture that is designed to improve performance of predictors and speed up calculations. Trading graphs, data mining features and predictive algorithms are predominantly based on fractal mathematics and Chaos theory. Even the unique software architecture is fractal in nature. All of these features are intended to be used individually or collectively to improve forecasting performance of financial markets.

Another example is found in U.S. Pat. No. 7,991,672 which teaches a system and method for calculating and arraying an entire universe of publicly traded stock performance data, technical and dynamic range of movement stock price data, underlying operating corporate balance sheet plus income statement fundamental data and ratios, and derived corporate operating and stock analysis data in such a manner as to enable the data for any selected single company to be phased, combined and superimposed within a series of graphical illustrations, which enable investors to easily visualize and compare the relationship of stock price movement and the underlying progression of fundamental operating variables of companies listed on exchanges around the world. The system includes a server computer, one or more client computer(s) coupled to the server computer via the Internet, a database for storing, identifying and extrapolating stocks data, one module for calculating a set of selected performance parameters pursuant to a set of preset standards, a module for transforming calculation results of said calculation module into graphical illustrations; and a graphical user interface from which a user may send an inquiry to the server computer and be returned with a set of graphical illustrations on the inquired stock performance.

### SUMMARY OF THE INVENTION

According to an aspect of some embodiments of the present invention there is provided a computerized method of financial data analysis. The method comprises

calculating, using a processor, for each member of a first group of a plurality of publically traded financial instruments, a current growth grade according to combination of a plurality of growth factor scores and a current value grade according to a combination of a plurality of value factor scores, generating a presentation depicting the distribution of a plurality of members of the first group according to their growth and value factor scores, receiving from a user a correlation between a range of value grades and a range of growth grades, the correlation being selected according to the presentation, selecting a second group of the publically traded financial instruments according to historical financial data so that each member thereof having growth and value grades which correspond with the value and growth grade ranges in a past period, performing at least one back testing simulation to members of the second group according to financial data from the past period, and presenting the outcome of the at least one testing simulation to the user.

Optionally, the receiving comprises automatically selecting a subgroup of the first group so that each member thereof having growth and value grades which correspond with the range of value grades and the range of growth grades and automatically building a portfolio which includes members of the subgroup.

More optionally, the method comprises automatically performing a plurality of transaction to purchase and manage the portfolio.

More optionally, the correlation is manually selected by marking at least one area of interest on the presentation; wherein the subgroup comprising currently publically traded financial instruments which are presented as marks within the at least one area of interest.

More optionally, the automatically performing comprises selecting at least one member of the subgroup for trading based on a combined grade calculated according to a combination of value and growth grades.

Optionally, the method comprises managing a dataset having historical financial data pertaining to at least some of the plurality of publically traded financial instruments; the historical financial data comprises growth and value factor scores measured during a past period of at least one year; wherein the selecting is performed by an analysis of the dataset.

More optionally, the method further comprises monitoring at least one online financial data source to update the growth and value factor scores in the dataset.

Optionally, the presentation is a multidimensional graphical presentation depicting each member of the first group as an object in a graphical structure based on respective the current growth and value grades.

More optionally, the graphical structure is a two dimensional grid having a current growth grade axis and a current value grade axis.

Optionally, the calculating comprises normalizing the plurality of growth and value factor scores.

Optionally, the calculating comprises receiving a plurality of relative weights from the user and weighting the plurality of growth and value factor scores according to respective the plurality of relative weights.

Optionally, the method comprises receiving a plurality of simulation parameters from a user and performing the at least one back testing simulation according to the plurality of simulation parameters.

More optionally, the plurality of simulation parameters includes at least one member of a group consisting of an historical purchase date, a historical sell date, a max number of stocks, an investment size, a stock holding period, a rebalance period, a weight method, a benchmark reference, a stock management commission, and a minimum volume.

More optionally, the receiving comprises automatically selecting a subgroup of the first group so that each member thereof having growth and value grades which correspond with the range of value grades and the range of growth grades and automatically building a portfolio which includes members of the subgroup; further comprising automatically performing a plurality of transaction to purchase and manage the portfolio according to the plurality of simulation parameters.

Optionally, the method comprises filtering the first group according to a plurality of filtering parameter received from the user.

Optionally, the calculating scaling the plurality of growth and value factor scores according to a user set scale.

More optionally, the method further comprises setting according to a user input at least one dynamic control rule for monitoring changes of members of the second group during the back testing simulation and emulating at least one trading transaction according to the at least one dynamic control rule.

Optionally, the selecting and performing are repeated in a plurality of simulation sessions to generate a plurality of simulation outputs; wherein the presenting comprises grading each the simulation output according to at least one return parameter and at least one risk parameter and arranging the plurality of simulation outputs according to the grading.

More optionally, the performing comprises weighting the at least one return parameter and the at least one risk parameter according to a user input.

According to an aspect of some embodiments of the present invention there is provided a system of financial data analysis. The system comprises a processor and a dataset which stores historical financial data pertaining to a plurality of publically traded financial instruments, a growth and value module which calculates, using the processor current growth and value grades respectively according to a plurality of growth and value factor scores for each member of a first group of the plurality of publically traded financial instruments, a presentation module which forwards the growth and value grades of each the publically traded financial instrument to a client terminal of the user to facilitate generating a grade indicative presentation, an input module which receives from a user a correlation between a range of value grades and a range of growth grades, the correlation being selected by the user according to the grade indicative presentation, and a simulation module performs at least one back testing simulation to each member of a second group of the publically traded financial instruments according to financial data documenting at least a past period, each member of the second group having growth and value grades with the value and growth grade ranges during the past period. The outcome of the at least one testing simulation being forwarded to the client terminal.

According to an aspect of some embodiments of the present invention there is provided a computerized method of generating a graphical presentation of a distribution of grades given to publically traded financial instruments. The method comprises calculating, using a processor, for each member of a plurality of publically traded financial instruments, current growth and value grades respectively according to a plurality of growth and value factor scores, generating a multidimensional graphic presentation having a multidimensional grid with a plurality of graphical indicators distributed indicative of the plurality of publically traded financial instruments thereon so that a location of each the graphical indicator is indicative of growth and value grades of a respective the publically traded financial instrument, allowing a user to mark at least one area of interest of the multidimensional graphic presentation, the at least one area is indicative of a correlation between a range of value grades and a range of growth grades, automatically selecting a group of the plurality of publically traded financial instruments based on a respective group of the plurality of graphical indicators depicted within the boundaries of the at least one marked area of interest, and outputting the selected group.

Optionally, the generating comprises coloring the plurality of graphical indicators with a plurality of colors each indicative of a different company related characteristic of a common group.

More optionally, the company related characteristic is selected from a group consisting of a market capitalization value group, an industrial sector, a trading exchange market, and a country of origin.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of performing back testing simulation according to user selected growth and value grade ranges, according to some embodiments of the present invention;

FIG. 2 is a schematic illustration of a system which performs a back testing simulation based on a group of publically traded financial instruments, according to some embodiments of the present invention;

FIG. 3 is a flowchart of a process of setting growth and value grades to a publically traded financial instrument, according to some embodiments of the present invention;

FIG. 4A is a schematic illustration of an exemplary graphical user interface for scaling and weighting normalized scores of value and growth factors, according to some embodiments of the present invention;

FIG. 4B is a schematic illustration of an exemplary 2D grid with a plurality of stocks which are mapped according to value and growth grades, according to some embodiments of the present invention;

FIG. 4C is a magnification of the area at the top right corner of the 2D grid depicted in FIG. 4B, according to some embodiments of the present invention;

FIG. 4D is a selection of an area of interest which is indicative of selected publically traded financial instruments and/or correlated value and growth grade ranges, according to some embodiments of the present invention;

FIG. 5 is an exemplary screenshot of a graphical user interface, according to some embodiments of the present invention;

FIGS. 6A and 6B are screenshots of a user interface that is used to present the outcome of a simulation, according to some embodiments of the present invention;

FIG. 7 is an exemplary table with outcome(s) of a list of simulations, according to some embodiments of the present invention;

FIG. 8 is an exemplary graphical user interface that allows a user to grade and relatively weight risk and/or return values for grading of the simulations, according to some embodiments of the present invention;

FIG. 9 is a grid mapping risk and/or return values of simulations, according to some embodiments of the present invention; and

FIG. 10 is an exemplary screenshot of an exemplary graphical user interface that depicts, according to some embodiments of the present invention.

### DESCRIPTION OF EMBODIMENTS OF THE INVENTION

The present invention, in some embodiments thereof, relates to financial data and, more particularly, but not exclusively, to methods and systems of historical and current financial data analysis.

According to some embodiments of the present invention, there are provided methods and systems of simulating, for example by back testing, the performance of publically traded financial instruments having value and growth grades consistent with user selected correlated value and growth grade ranges. The simulation is performed on historical financial data of publically traded financial instruments having value and growth grades which are consistent with respective correlated value and growth grade ranges at a documented past period. The outcome of the simulation may assist a user in creating portfolio(s) with high chances of achieving excess return in comparison with a benchmark, such as S&P 500, the Dow Jones Industrial Average (DJIA), the Russell 2000 Index, the MSCI World, The Euro STOXX 50, and the like. The excess return is achieved over a relatively long investment term, for example more than one or more weeks, for example one month, two month, three month or any intermediate or longer terms. In addition, the simulating allows estimating return and risk parameters of a portfolio with these financial instruments. Optionally, the simulation is performed according to user selected parameters. In such an embodiment, a portfolio with these financial instruments is managed according to parameters of the simulation. Optionally, the simulation is performed under one or more dynamic control rules. These rules adjust the simulation according to dynamic changes and/or a dynamically estimated risk. Optionally, a number of simulations are performed each according to different user selected parameters. In such an embodiment, simulations may be graded according to their return or risk parameters.

Optionally, the correlated ranges are set according to one or more areas of interest which are marked by a user on a multidimensional graphic presentation, for example a two dimensional grid, which depicts the distribution of a plurality of publically traded financial instruments according to their value and growth grades. The correlated value and growth grade ranges are ranges, which are selected simultaneously in response to a common user action, for example the marking of one or more areas of interest in a multidimensional graphic presentation depicting distribution of financial instrument grades and/or the like.

In use, a financial instrument's growth grade is calculated by combining scores of respective growth factors and a financial instrument's value grade is calculated by combining scores of respective value factors. These factors are optionally monitored and documented in a dataset. The factor scores are optionally normalized. The factor scores are optionally scaled and/or weighted according to user's inputs.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

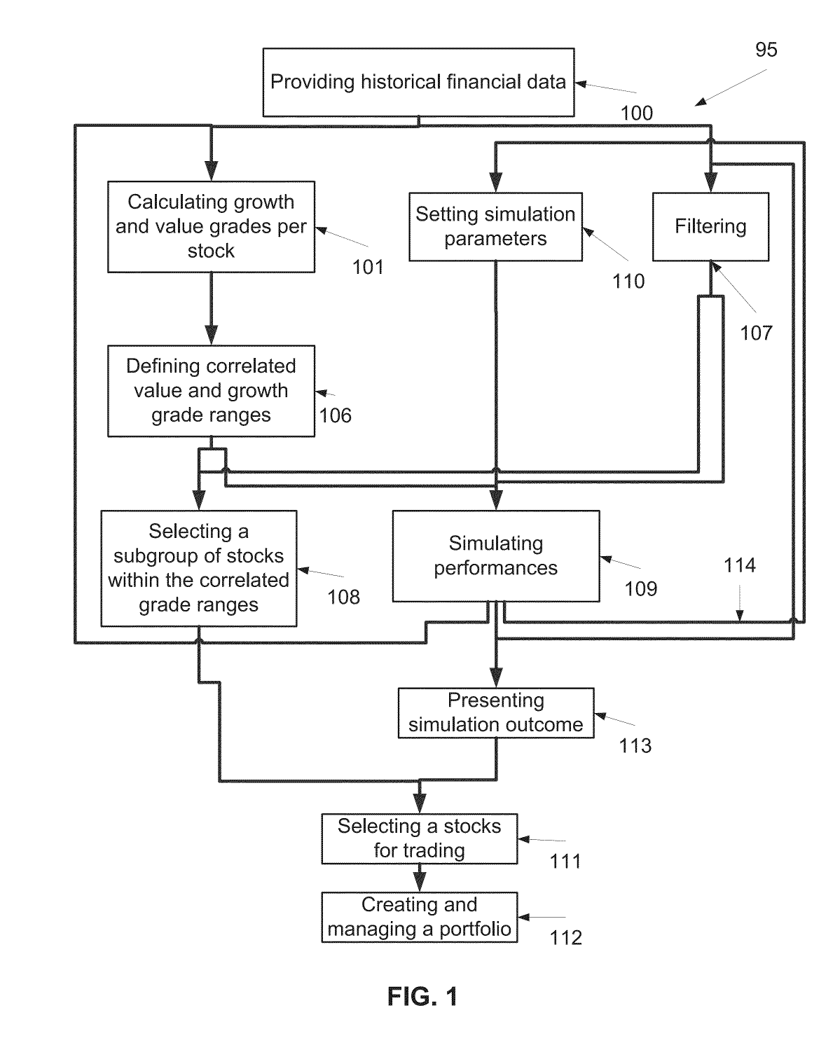

Reference is now made to FIG. 1, which is a flowchart of a method 95 using a historical financial data of a plurality of publically traded financial instruments to perform back testing simulation based on user selected growth and value grade ranges, according to some embodiments of the present invention. As used herein publically traded financial instruments are stocks, bonds, market currencies, derivatives, commodities and/or any other publically element which is merchandisable in one or more financial marketplaces.

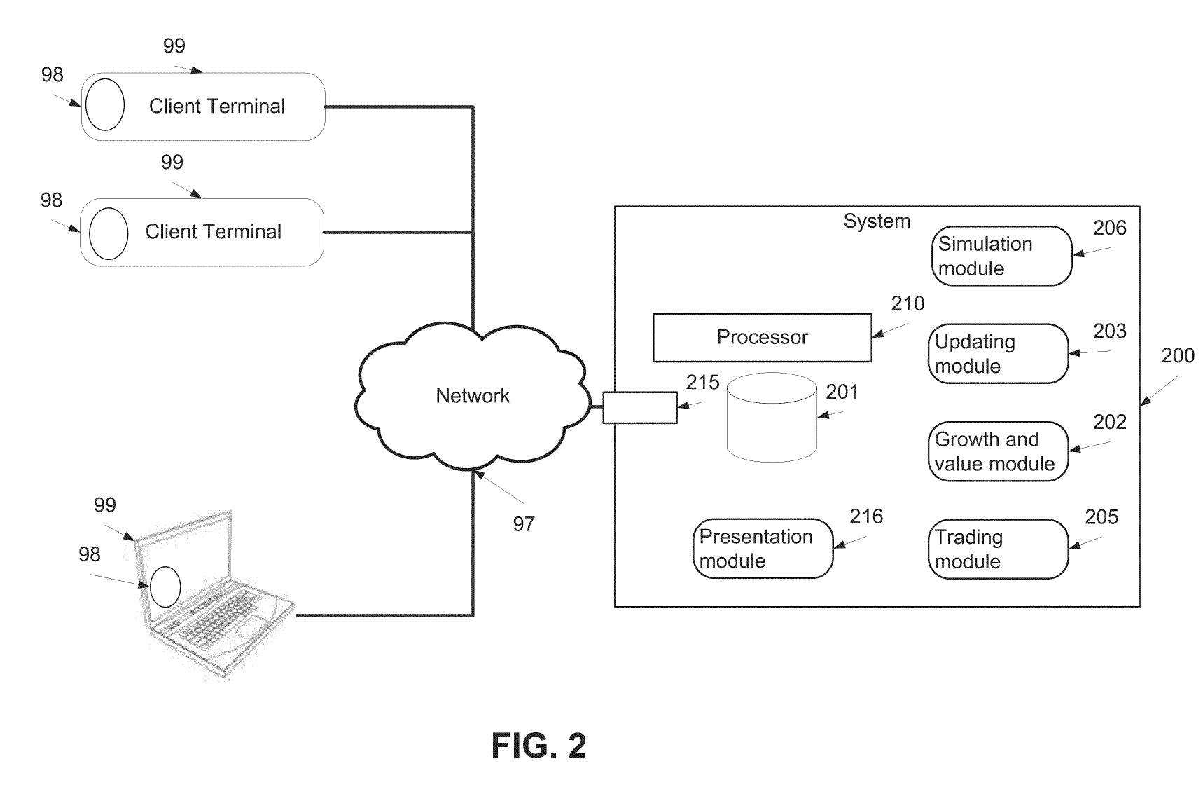

Reference is also made to FIG. 2, which is a schematic illustration of a system which performs a back testing simulation based on a group of publically traded financial instruments, according to some embodiments of the present invention. The system includes a central unit 200 which includes or is connected to a database 201, a presentation module 216, an input module 215, an updating module 203, a simulation module 206, a growth and value module 202, and a trading module 205. Optionally, the system includes or communicates with a plurality of client modules 98 which are installed in a plurality of client terminals 99, such as such as customer premises equipments (CPEs), for example laptops, desktops, smartphones and/or tablets, which communicate with the central unit 200. The client module 98 may be implemented as a software component executed by the hosting client terminal 99, for example an application from an app store, an add-on, a standalone application and/or a hardware component that is installed in the hosting client terminal 99, for example an integrated circuit (IC). Optionally, the central unit 200 is connected to each one of the client terminals 99 via a network 97, such as the Internet and/or an Ethernet and/or WLAN.

First, as shown at 100, a dataset of historical and optionally current financial data of a plurality of publically traded financial instruments is provided, for example accessed and/or managed. The dataset is optionally stored in the database 201. Optionally, the dataset 201 includes raw financial data of each one of the publically traded financial instruments over a monitored period of a number of years, for example 5, 10, 15, 20, 25, and 30 years or any intermediate period. The dataset may be managed by a third party and/or stored on an external network node, such as a server, that is accessed for data analysis. Optionally, the dataset is stored as a relational structured query language (SQL) database. For example, the financial data may be acquired from a multitude of data sources. Then an arranging module examines the characteristics of the data (e.g., language, currency) and standardizes so that all data records correspond with one another.

Optionally, the dataset 201 is continuously updated, for example by an updating module 203, optionally in real time, to allow the selection of a group of publically traded financial instruments based on up to date information, for example as described below.

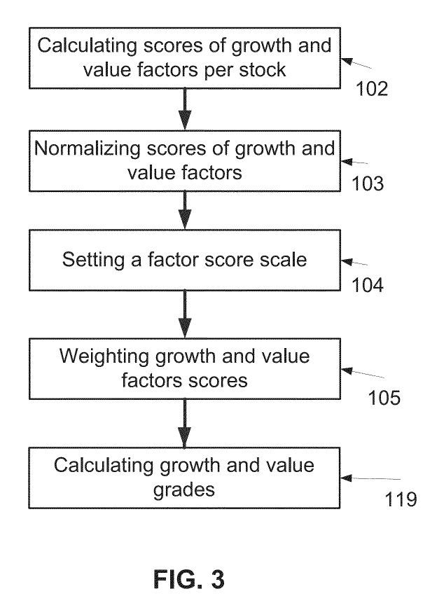

Now, as shown at 101, growth and value grades are calculated per each publically traded financial instrument. In the description below, the publically traded financial instrument is a stock however other publically traded financial instruments may be similarly analyzed and graded as described below. For example, reference is now also made to FIG. 3 which depicts an exemplary process of calculating growth and value grades per publically traded financial instrument, according to some embodiments of the present invention. Optionally, as shown at 102, scores of growth and value factors are calculated per stock, for example by the growth and value module 202, optionally using a processor 210. These factors are optionally a collection of quantifiable and measurable values that represent the performance of respective company during different times of the monitored period. Growth factors include factors which are indicative the company's growth, including but not limited to the following factors: relative strength index (RSI) for example for a period of three months, six months, and/or a year; earnings per share (EPS) growth percentage for example for a period of one year or 5 years; the percentage of growth of earning per share of a company between a past date and today for example a period between one year and 5 years; a revenue growth for example for a period of one year or 5 years; the percentage of growth of the company's revenues between a past date and today, for example for a period of one year or 5 years; a profit margin; a pre-tax margin; return on equity (ROE); return on capital (ROC); return on assets (ROA); and/or a grade which is based on analyst recommendations, for example between 1 and 5 based on multiple analysts' opinions.

Value factors include factors which are indicative of the value which the company provides to the owners of its stocks, including but not limited to the following factors: average volume, for example during a period between one month and 3 months; a daily average of an amount of shares traded for the respective stock a period, for example the during the last month or three months; price-earning ratio (P/E); price-book ratio (P/B); price-cash ratio (P/C); price-sales ratio (P/S); P-E to growth ratio (PEG ratio), dividend yield percentage, dividend yield growth, for example over a period of the last 5 years; current ratio, namely the current assets divided by current liabilities, quick ratio; and/or debt-equity ratio.

Optionally, as shown at 103, the scores of all the factors which the user chooses to use are normalized. For example, each factor is mapped to a factor score between 0 and 100 in a process which may be referred to herein as scoring.

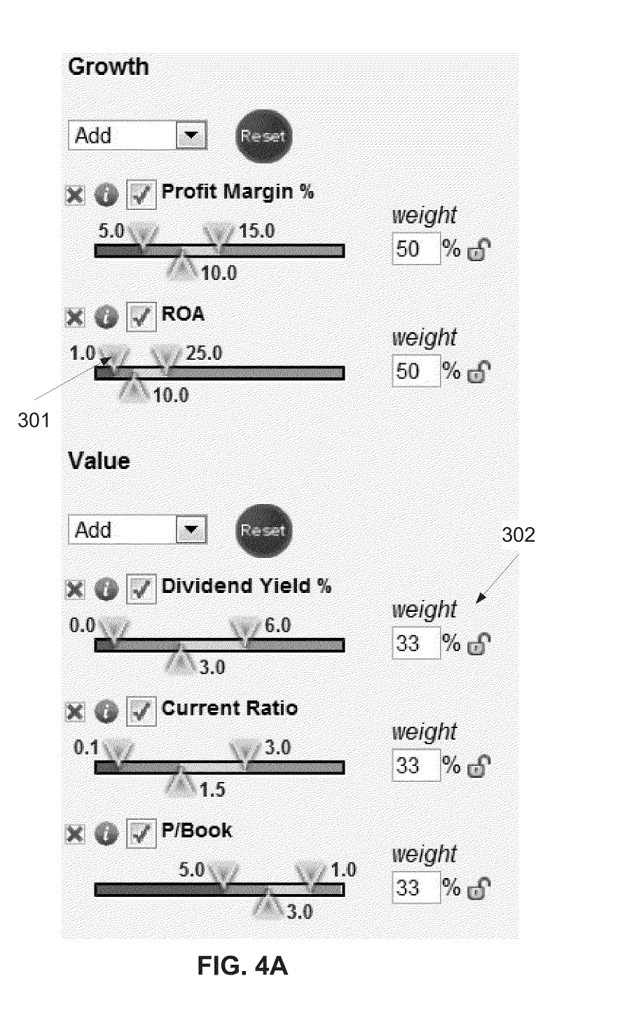

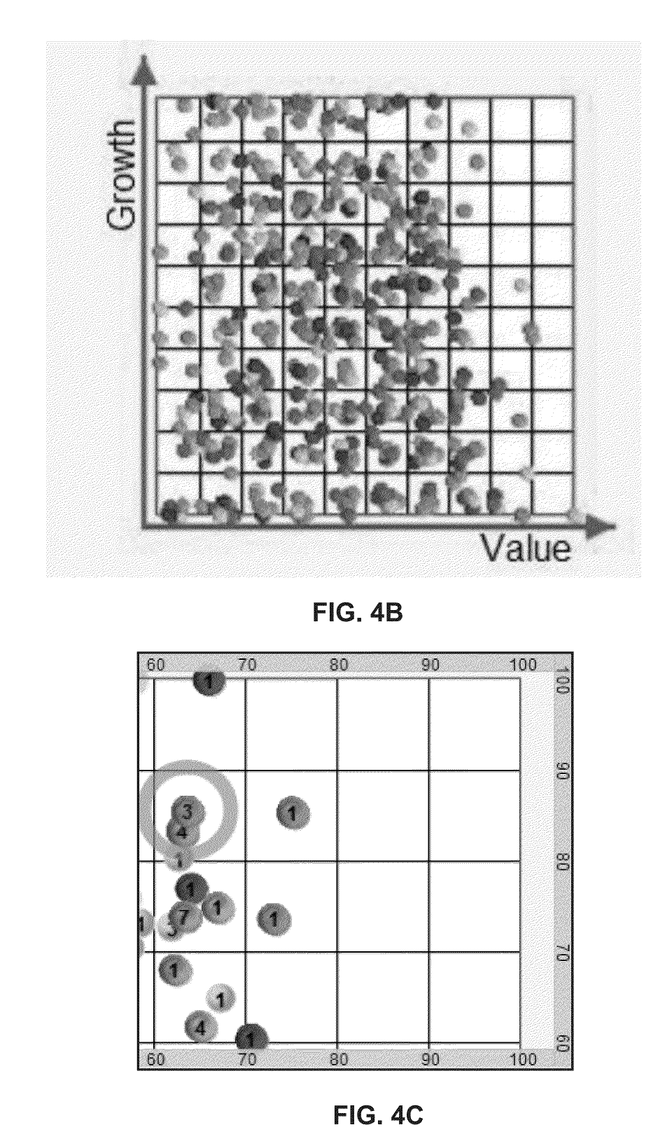

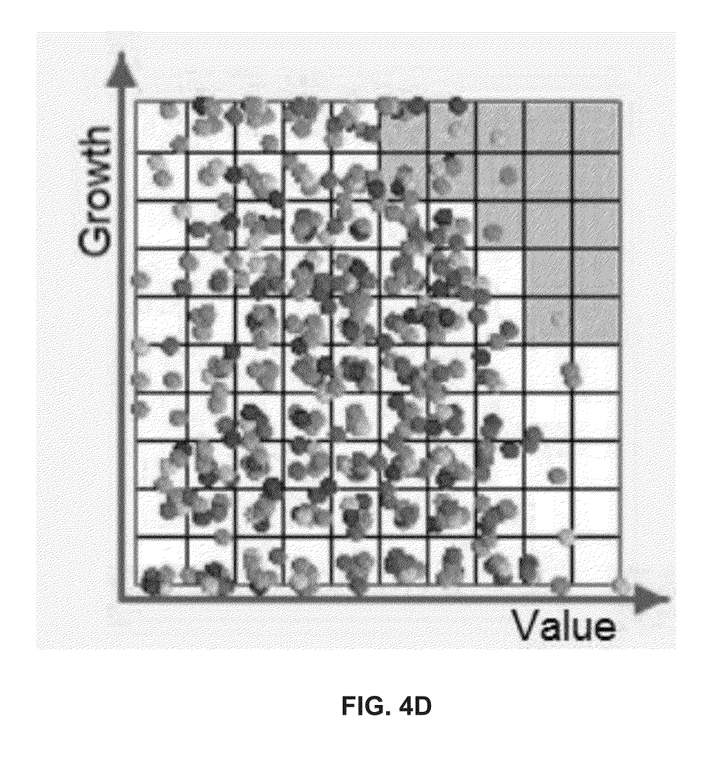

Now, as shown at 104, after the normalization is completed, a scoring scale is defined for each one of the growth and value factors. Optionally, the user defines a scale for each of one or more of the factors. The scale optionally includes a number of scoring values: excellent value—the value for which factor score 100 is awarded; medium value—the value for which factor score 50 is awarded; and bad value—the value for which factor score 0 is awarded. Optionally, a graphical user interface (GUI), for example as depicted in FIG. 4A is used to allow the user to set the scoring values. In FIG. 4A, numeral 301 depicts an exemplary cursor for indicating a factor score value on a scale. The GUI may include scrolling objects, textual object, and/or any other object that allows manually setting the scoring values.

Once these scoring values are defined it is easy to assign for each factor a factor score according to a scoring formula, for example as follows:
case where B<M<E:
If (F<=B)
then S=0
else if (F<=M)
then S=((F−B)/(M−B))*50
else if (F<=E)
then S=50+((F−M)/(E−M))*50
else S=100
case where B>M>E:
If (F>=B or F<=0)
then S=0
else if (F>=M)
then S=((B−F)/(B−M))*50
else if (F>=E)
then S=50+((M−F)/(M−E))*50
else S=100

where F denotes a factor, S denotes a factor score to be calculated and E, M, and B denote the values defined as excellent, medium and bad respectively. These values are optionally in ascending or descending order. Clearly more grades may be defined.

Optionally, as shown at 105, a score of each value and/or growth factor may be weighted in relation to other value and/or growth factors. For example, in FIG. 4A, numeral 302 is indicative of an exemplary text box for defining a weight value.

As shown at 119, using the factor scores, which are optionally normalized and weighted, a weighed growth grade (WGG) and a weighted value grade (WVG) are calculated per stock and optionally referred to herein as grades or stock grades. For example, the WGG is calculated as follows:

WGG=(FS1*GW1+ . . . FSn*GWn)/((GW1+ . . . GWn)

where FS1, . . . , FSn denote factor scores corresponding to growth factors, GW1, . . . , GWn denote weights corresponding to the growth factors, and WGG denotes the resulted weighted growth grade.

The WVG is optionally calculated as follows:

WVG=(VS1*VW1 + . . . VSn*VWm)/(VW1+ . . . VWm)

where VS1, . . . , VSm denote the grades corresponding to value factors, VW1, . . . , VWm denote the weights corresponding to the value factors, and WVG denotes the resulted weighted value grade.

Now, as shown at 106, the user manually defines a correlation between a range of value grades and a range of growth grades, which are optionally normalized and/or weighted. As used herein, a value grade and a growth grade are grades given to a stock based on a combination of scores which are given to the respective factors.

Optionally, as shown at 107, the publically traded stocks are filtered, for example according to user defined filters, for instance based on market capitalization value, which is optionally calculated by multiplying the share price by the number of available shares, industrial sector, trading exchange market and/or country and/or the like. For example, a user may define a minimum and maximum value for market capitalization value and only companies in between these values will not be filtered out and thus excluded from consideration. In another example, only stocks of companies from selected industrial sector(s) are filtered and/or not filtered. In another example, stocks are filtered based on the stock markets and/or countries they are traded in.

As shown at 108, a subgroup of the publically traded stocks, which are optionally filtered as described above, are selected so that each member of the selected subgroup has growth and value grades which correspond with the manually defined range of value grades and range of growth grades.

The grade ranges, the correlation between the grade ranges, and optionally the filters define a strategy for picking stocks. The strategy may be set for high positive return or negative return (i.e. for options trade), used for long or short term stock purchases and/or the like, for example as exemplified below.

According to some embodiments of the present invention, a multidimensional graphical presentation of the publically traded stocks, which are optionally filtered, allows the user to mark the correlation in a graphical manner based on the presented data. The multidimensional graphical presentation is generated by the presentation module 216 and/or according to data that is received therefrom on the client module 98. The correlation is optionally marked simultaneously with the selection of the aforementioned subgroup, for example as described below. In these embodiments, the value and growth grades of the publically traded stocks, which are optionally based on normalized and weighted factor scores, are placed in a multidimensional graphical presentation. Each grade is optionally between 0 and 100. For example, the multidimensional graphical presentation is a two dimensional (2D) grid, where each stock is presented by a graphical indicator, such as dot. For example, FIG. 4B depicts an exemplary 2D grid with a plurality of stocks which are mapped according to their value and growth grades. Stocks with high grades are depicted as dots at the top-right corner of the grid and stocks with low grades are depicted as dots at lower-left corner. Stocks with high growth grades are at the top rows of the grid and stocks with high value grades are at the right column(s). This multidimensional graphical presentation allows mapping a full universe of publically traded stocks onto a 2D grid in a format that enables the user to quickly identify stocks representing the balance of growth grade and value grade that the user is interested in.

Optionally, as shown at FIG. 4B, an additional dimension is added to the multidimensional graphical presentation, for example by coloring the dots. For example, different colors may be given to stocks of companies from different industries, for example according to the following deviation: industrial companies, financial related companies, healthcare, technology, cyclical consumer goods and/or services, energy, utilities, basic materials, non-cyclical consumer goods and/or services, and telecommunications services. This allows users to receive more information when looking at the 2D grid.

Optionally, the 2D grid is divided to areas, for example 10×10 squares, which represent grade ranges, for example between 20 and 30 value grades and between 40 and 50 growth grades. Optionally, the user may magnify any area of the 2D grid. For example, FIG. 4C depict a magnification of the area at the top right corner of the 2D grid depicted in FIG. 4B, filtered based on coloring segmentation.

It should be noted that color may be used to image other attributes of the stocks, for example origin country of a company of a respective stock and/or a market capitalization value percentile. With this approach color is used to differentiate slices of the market for easier viewing. It should be noted that attributes may also be represented by numbers which are printed on top of the dots, for example as shown at FIG. 4C, and/or the like.

Now, the user may graphically mark the correlation between value and growth grade ranges, for example by selecting one or more areas of interest on the multidimensional graphical presentation. The areas of interest are optionally selected by marking one or more squares on the 2D grid, for example as depicted by the highlighted squares line at the top right portion of FIG. 4D.

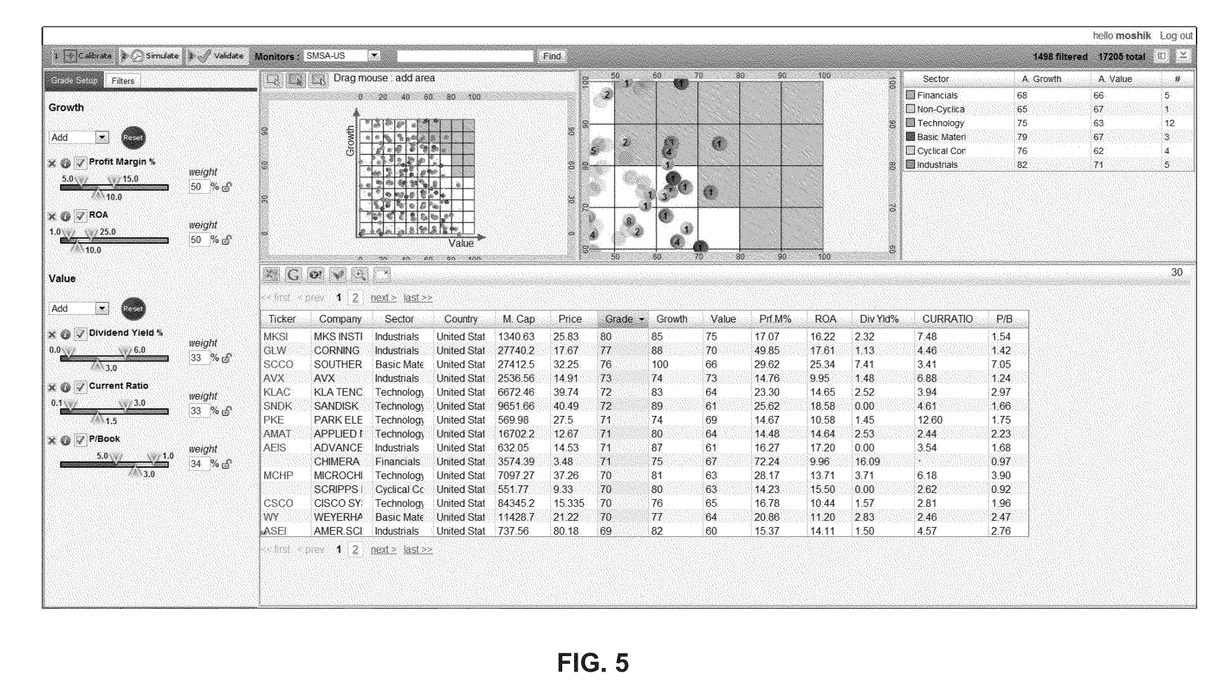

Optionally, data pertaining to the stocks in the marked area, namely within the correlated grade ranges, may be presented in a stock table; for example, see FIG. 5 that depicts an exemplary screenshot of a GUI having a table with respective characteristics of selected stocks in the area of interest.

As shown at 109, a simulation is set on a simulation group that comprises publically traded stocks selected from the dataset that is optionally stored in the database 201. Each member of the simulation group has growth and value grades that consistent with the correlated value and growth grade ranges. The simulation is managed by the simulation module 206.

Optionally, as shown at 110, the user sets a number of parameters for the simulation. For example, the simulation parameters include one or more of the following: an historical purchase date, a historical sell date, a max number of stocks, an investment size, a stock holding period, a rebalance period, a weight method, a benchmark reference, a stock management commission, and/or a minimum volume.

Now, a simulation is activated by the simulation module 206 according to the user definition(s). It should be noted that the simulation is optionally managed on the central unit 200, facilitating the user to continue his work with the system for example to define other simulations using her client terminal 99. During the simulation, which is optionally a back testing simulation, a series of transactions are emulated on the historical data, starting at the historical purchase date, and ending at the historical sale date, in a plurality of simulation intervals. An interlude between simulation intervals is defined by the stock holding period parameter. In each simulation interval, a number of stocks are selected so that at the historical purchase date, their value and growth grades consistent with the correlated grade ranges, for example as defined by the marked area of interest in the 2D grid.

Optionally, between the simulation intervals, a number of stocks, bounded by the maximum number of stocks requirement, which have a highest combination of value and growth grades during the respective past period are selected. For example, the stocks which have the highest grade based on a formula combining respective value and growth grades. For instance, such a combination may be referred to herein as a final grade (FG) and optionally defined as follows:

FG=100−Square Root [(100−WGG)̂2+(100−WVG)̂2]*0.7071

During the simulation, the purchase of stocks is simulated according to the investment size parameter. Optionally, stocks with the highest FG are selected and then, if needed, others are virtually sold. Optionally, the total return of the simulation is calculated during each period. Optionally, the share of each stock in the simulation is determined according to a weight method parameter. For example, the capital invested for purchasing each one of the shares may be equal, set according to their market cap so that the value of large-cap shares and/or small-cap shares is above a minimum threshold and/or the like.

Optionally, virtual commission is calculated per virtual transaction, for example as a fixed amount and/or as a percentage from the transaction.

Optionally, during the simulation, if a minimum volume parameter is set, the average simulated daily volume of a stock over the respective last month is checked before each virtual buy/sell transaction. If the stock does not meet a necessary criteria, it is either virtually skipped and the next suitable stock with the highest FG is virtually bought and/or virtually sold for as much as possible according to the historical financial data. Optionally, each simulated month the system checks for virtual dividend distribution for all the stocks in the portfolio and adds the outcome to the total, to be used in the next virtual transaction.

Optionally, dynamic control rules are implemented during the simulation. The applying of these rules is intended to handle market extreme situations such as a crash. For example, the rules may define the following:

take profit (TP) % rule—sale stock when achieving a profit of more than a certain percentage;

TP cool down rule—wait a certain period after TP % rule is implemented;

Stop Loss % rule—each stock which loses a certain percentage from its value is sold;

SL cool down rule—wait a certain period after Stop Loss % rule is implemented;

Trailing SL (T/SL) % rule—sale a stock which loses a certain percentage from its highest peak;

T/SL cool down rule—wait a certain period after T/SL % rule is implemented;

Time Limit rule—each stock is kept in the portfolio for no more than a maximum period, for example a certain number of days; and

Portfolio SL(%)—each time the sum of the current value of the stocks is decreased by a certain percentage, no new stocks are purchased from the money acquired from the sale of the stocks for at least a period, which is optionally set by the user (i.e. PSL cool down rule).

The dynamic control rules may be enforced during the simulation continuously and/or in a plurality of intervals, for example every few hours, days, weeks, and/or months of simulated trade, for example once a month.

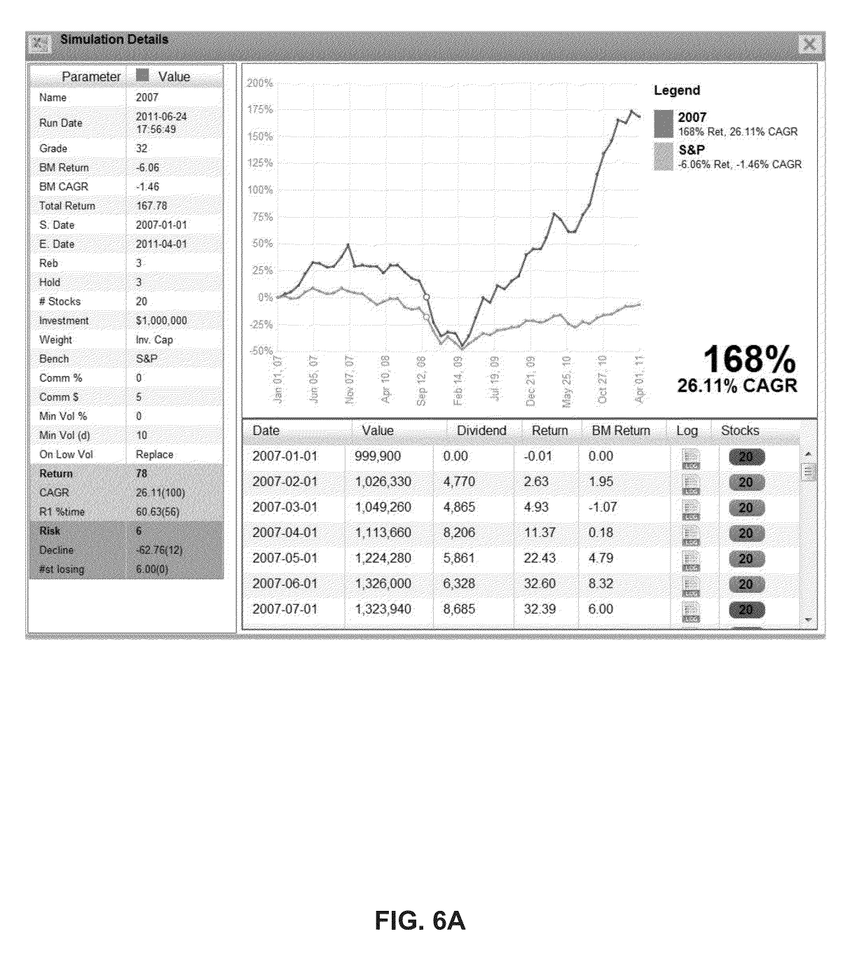

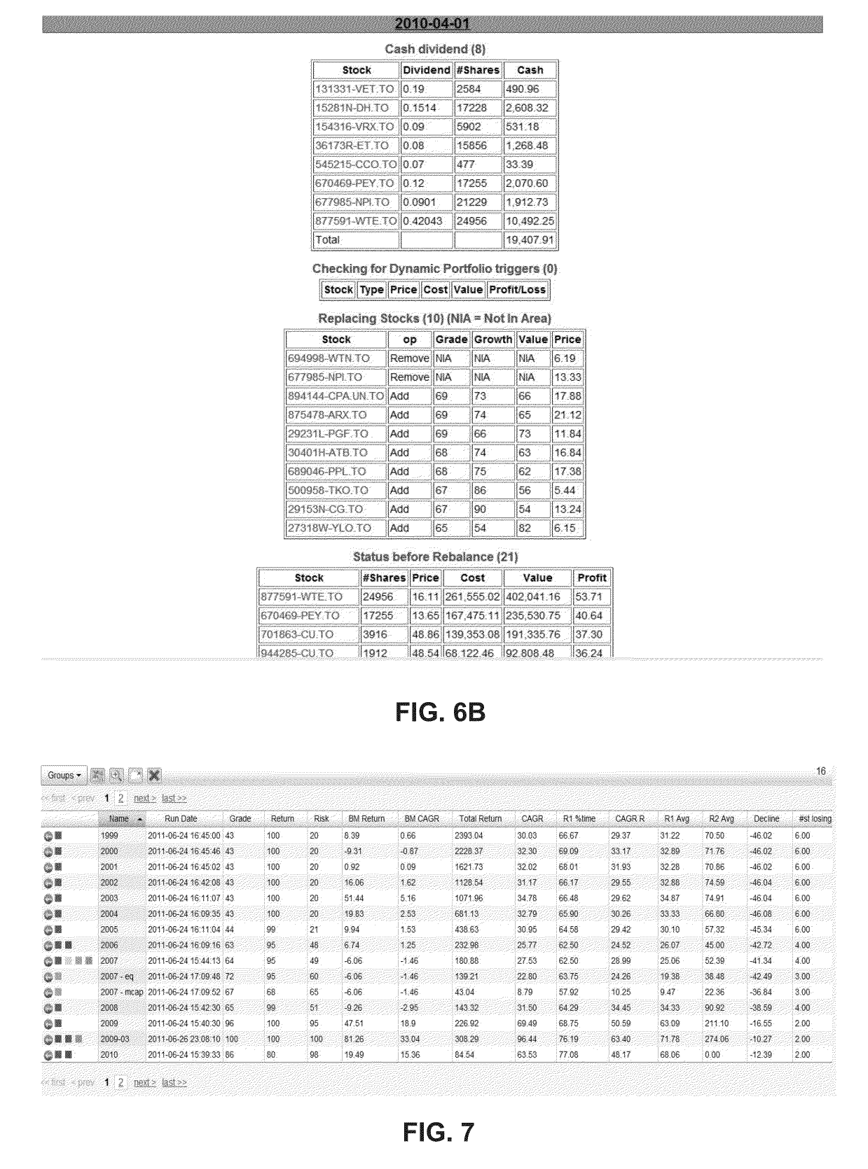

Now, as shown at 113, the outcome of the simulation is presented to the user. Optionally, the simulation results are displayed in a graphical form and/or in a table, for example in an alphanumerical form. The results are optionally referenced to a benchmark that is specified by the user, for example as described above. In addition, a detailed log is provided containing all the transactions which have been performed during the simulation, stocks purchased and/or sold, optionally including reasons (i.e. according to which dynamic control rule(s)), dividends distributed and commissioned deducted. For example, FIGS. 6A and 6B depict screenshots of a user interface presents the outcome of a simulation. In FIG. 6A, the total value of simulated portfolio is shown on a graph together with a benchmark. In FIG. 6B, logs of various transactions are shown.

The simulation allows calculating the total return of the simulation over a simulated period. For example, as depicted in FIG. 6A, the compound annual growth rate (CAGR) is measured for the portfolio and for the selected benchmark. The CAGR is optionally calculated as follows:

CAGR(in %)=((1+RET/100)̂(1/NY)−1)*100

where RET denotes total Return (in percentage) and NY denotes number of years. In addition to the total return and the CAGR, the simulation yields various other measurements which are optionally classified. For example, one or more of the following simulation return measurements are calculated: CAGR absolute ABS) percentage, CAGR relative to benchmark, rolling 1, 2 and 3 years average returns in percentage, rolling 1, 2 and 3 years average returns relative to Benchmark in percentage, and the relative time the simulated portfolio has a higher return than the benchmark. For example, one or more of the following risk measurements are calculated: worst decline(s), worst decline(s) decline in the simulated portfolio relative to worst decline(s) in the benchmark, highest number of losing months, the relative time the simulated portfolio has lower performances than the benchmark, a standard deviation, and Sharpe ratio.

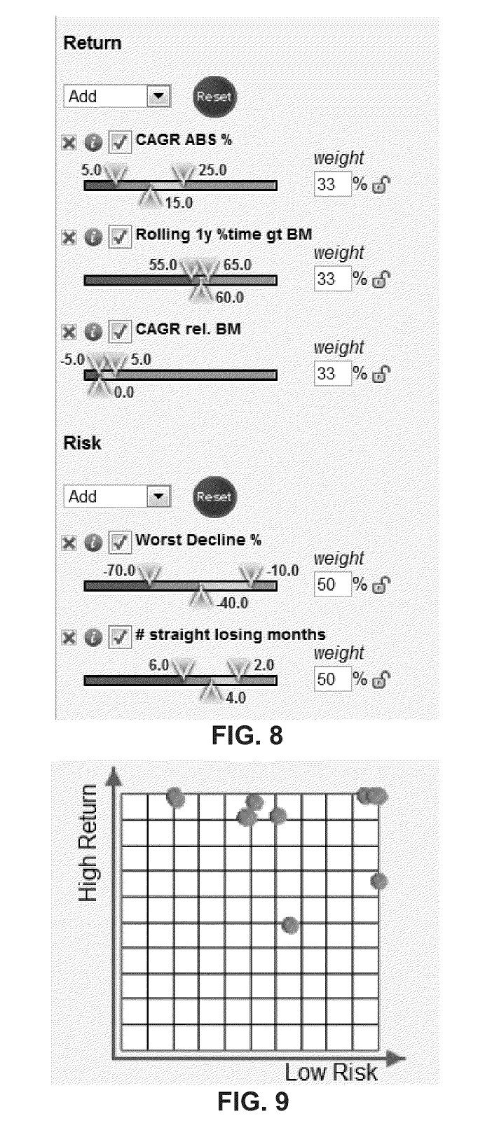

As shown by the arrowed line at 114, blocks 110 and 109 may be repeated iteratively so that a plurality of simulations may be held based on the correlated grade ranges and new simulation parameters and/or based on new correlated grade ranges and new and/or previously used simulation parameters. Optionally, the outcomes of the simulations are presented in a table, where each line represents one simulation, including all its parameters and results. This table can be sorted by any desired column. The simulation name can be changed to a meaningful title and in addition, multiple, customizable tags can be added to each line. These colorful tags can be used for filtering the table for easy viewing. For example, FIG. 7 depicts an example of such a table with outcome(s) of a list of simulations. Optionally, the simulations are graded, for example according to return and/or risk parameters. For example, FIG. 8 depicts a GUI that allows a user to grade and relatively weight the effect of risk and/or return factors on the grading of the simulations. Using the GUI, the user defines the scale and weight for various risk and return measurements. Similar to the aforementioned scoring of factors of stocks, for example as described with reference to FIG. 4A, the user may define excellent, medium and bad values for each one of these values. Weights may also be defined using a default profile. After the weight is defined, each simulation receives a return value and a risk value, each between 0-100. This way the simulations may be placed in a risk/return map, for example as depicted in FIG. 9 where simulations that show high return and low risk are at the top right section of the 2D grid and the simulations that show low return and high risk are at the bottom left of the 2D grid.

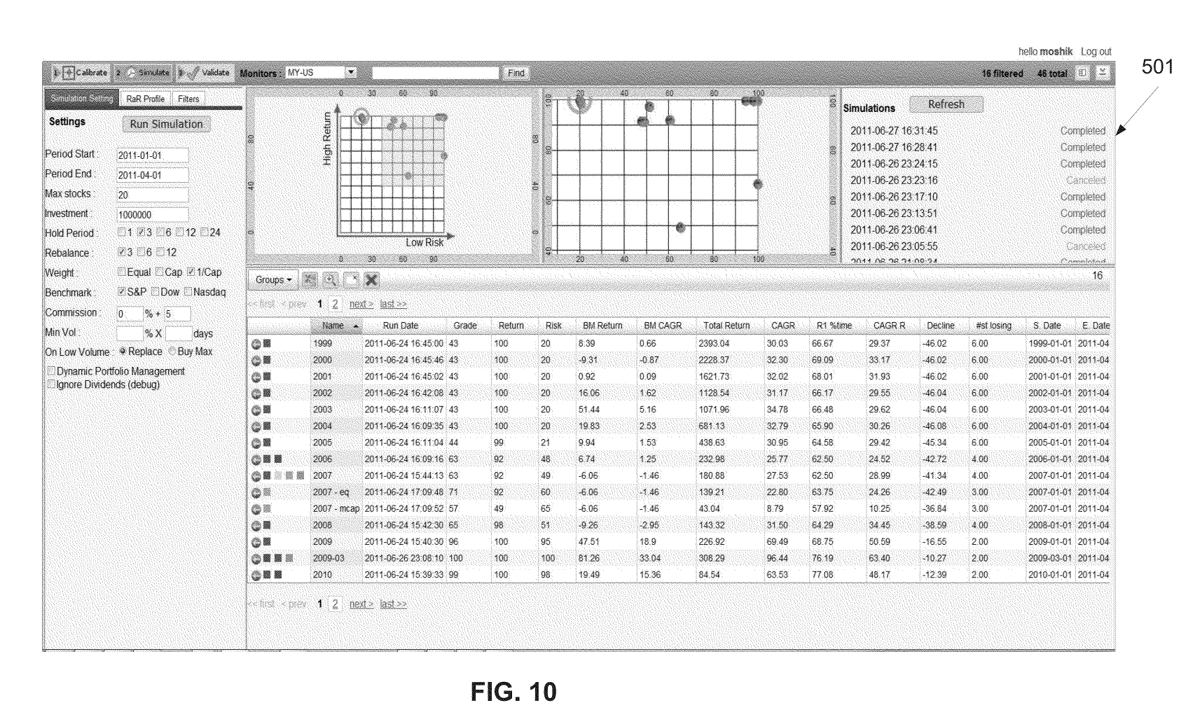

FIG. 10 is an exemplary screenshot of a GUI that depicts the components described above. The GUI further includes a sub window 501 which contains a running list of statuses of simulations which are currently executed, canceled and/or completed. These simulations may be requested by one client and presented to others, optionally if they have the same account.

Now, as shown at 111, the user may select a preferred simulation. Then, as shown at 112, an actual stock portfolio may be managed according to the definition of the preferred simulation, for example with the respective value and growth grade ranges, filters, and/or dynamic control rules.

For example, one or more of the following parameters are set according to the selected simulations: a simulation to be used for building the portfolio; maximum number of stocks; an amount of capital to invest; a percentage of capital to reserve; a commission; a weighting method; a holding period; a rebalance period; a benchmark to use; and one or more dynamic control rules to use.

It should be noted that the portfolio parameters may be set automatically according to the respective simulation parameters of the selected simulation and/or adjusted by the user.

Now, in use, the trading module 205 makes transactions according to the selected simulation. The trading module 205 optionally makes transactions in a similar manner to the simulated transactions in the selected simulation, for example based on the FGs of the stocks, the correlated grade ranges which have been selected by the user, and/or the maximum number of stocks requirement.

The stocks which are selected for purchase are optionally presented to the user, for example listed for the user's review. Optionally, the user may add stocks to the portfolio at the current prices with quantities according to the current weight method, optionally by clicking on a single button. It is up to the user, at this point, to take the created list of stocks, with quantities, and buy them using his preferred broker services.

Optionally, updating module 203 updates the database periodically, for example daily. Consequently, stocks in the portfolio dynamically change their status.

When no dynamic control rules are used, at each holding period the trading module 205 evaluates the stocks in the portfolio and may recommend replacing some of the stocks by other that have better FG. Optionally, the trading module 205 recommends removing from the portfolio stocks that have value and growth grades that consistent with the correlated grade ranges and/or in the area of interest. Optionally, each rebalance period the system may recommend to change the quantities of the stocks inside the portfolio, without adding and/or removing stocks, in order to maintain the weight method. Optionally, the trading module 205 adds dividends for stocks in the portfolio as they are distributed. Optionally, the trading module 205 maintains the returns of all transactions in the portfolio.

When dynamic control rules are used, the stock prices may be checked periodically, for example daily, the trading module 205 may recommend on removing stocks if necessary and replacing them with new ones according to the dynamic control rules.

It is expected that during the life of a patent maturing from this application many relevant systems and methods will be developed and the scope of the term computing unit, network, client terminal and a server is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of financial data analysis, comprising:
calculating, using a processor, for each member of a first group of a plurality of publically traded financial instruments, a current growth grade according to combination of a plurality of growth factor scores and a current value grade according to a combination of a plurality of value factor scores;
generating a presentation depicting the distribution of a plurality of members of said first group according to their growth and value factor scores;
receiving from a user a correlation between a range of value grades and a range of growth grades, said correlation being selected according to said presentation;
selecting a second group of said publically traded financial instruments according to historical financial data so that each member thereof having growth and value grades which correspond with said value and growth grade ranges in a past period;
performing at least one back testing simulation to members of said second group according to financial data from said past period; and
presenting the outcome of said at least one testing simulation to said user.

2. The method of claim 1, wherein said receiving comprises automatically selecting a subgroup of said first group so that each member thereof having growth and value grades which correspond with said range of value grades and said range of growth grades; and
automatically building a portfolio which includes members of said subgroup.

3. The method of claim 2, further comprising automatically performing a plurality of transaction to purchase and manage said portfolio.

4. The method of claim 2, wherein said correlation is manually selected by marking at least one area of interest on said presentation; wherein said subgroup comprising currently publically traded financial instruments which are presented as marks within said at least one area of interest.

5. The method of claim 2, wherein said automatically performing comprises selecting at least one member of said subgroup for trading based on a combined grade calculated according to a combination of value and growth grades.

6. The method of claim 1, further comprising managing a dataset having historical financial data pertaining to at least some of said plurality of publically traded financial instruments, said historical financial data comprises growth and value factor scores measured during a past period of at least one year; wherein said selecting is performed by an analysis of said dataset.

7. The method of claim 6, further comprising monitoring at least one online financial data source to update said growth and value factor scores in said dataset.

8. The method of claim 1, wherein said presentation is a multidimensional graphical presentation depicting each member of said first group as an object in a graphical structure based on respective said current growth and value grades.

9. The method of claim 8, wherein said graphical structure is a two dimensional grid having a current growth grade axis and a current value grade axis.

10. The method of claim 1, wherein said calculating comprises normalizing said plurality of growth and value factor scores.

11. The method of claim 1, wherein said calculating comprises receiving a plurality of relative weights from said user and weighting said plurality of growth and value factor scores according to respective said plurality of relative weights.

12. The method of claim 1, further comprising receiving a plurality of simulation parameters from a user and performing said at least one back testing simulation according to said plurality of simulation parameters.

13. The method of claim 12, wherein said plurality of simulation parameters includes at least one member of a group consisting of an historical purchase date, a historical sell date, a max number of stocks, an investment size, a stock holding period, a rebalance period, a weight method, a benchmark reference, a stock management commission, and a minimum volume.

14. The method of claim 12, wherein said receiving comprises automatically selecting a subgroup of said first group so that each member thereof having growth and value grades which correspond with said range of value grades and said range of growth grades and automatically building a portfolio which includes members of said subgroup; further comprising automatically performing a plurality of transaction to purchase and manage said portfolio according to said plurality of simulation parameters.

15. The method of claim 1, further comprising filtering said first group according to a plurality of filtering parameter received from said user.

16. The method of claim 1, wherein said calculating scaling said plurality of growth and value factor scores according to a user set scale.

17. The method of claim 1, further comprising setting according to a user input at least one dynamic control rule for monitoring changes of members of said second group during said back testing simulation and emulating at least one trading transaction according to said at least one dynamic control rule.

18. The method of claim 1, wherein said selecting and performing are repeated in a plurality of simulation sessions to generate a plurality of simulation outputs; wherein said presenting comprises grading each said simulation output according to at least one return parameter and at least one risk parameter and arranging said plurality of simulation outputs according to said grading.

19. The method of claim 18, wherein said performing comprises weighting said at least one return parameter and said at least one risk parameter according to a user input.

20. A computer readable medium comprising computer executable instructions adapted to perform the method of claim 1.

21. A system of financial data analysis, comprising:
a processor and a dataset which stores historical financial data pertaining to a plurality of public ally traded financial instruments;
a growth and value module which calculates, using said processor current growth and value grades respectively according to a plurality of growth and value factor scores for each member of a first group of said plurality of publically traded financial instruments;
a presentation module which forwards said growth and value grades of each said publically traded financial instrument to a client terminal of said user to facilitate generating a grade indicative presentation;
an input module which receives from a user a correlation between a range of value grades and a range of growth grades, said correlation being selected by said user according to said grade indicative presentation; and
a simulation module performs at least one back testing simulation to each member of a second group of said publically traded financial instruments according to financial data documenting at least a past period, each member of said second group having growth and value grades with said value and growth grade ranges during said past period;
wherein the outcome of said at least one testing simulation being forwarded to said client terminal.

22. A computerized method of generating a graphical presentation of a distribution of grades given to publically traded financial instruments, comprising:
calculating, using a processor, for each member of a plurality of publically traded financial instruments, current growth and value grades respectively according to a plurality of growth and value factor scores;
generating a multidimensional graphic presentation having a multidimensional grid with a plurality of graphical indicators distributed indicative of said plurality of publically traded financial instruments thereon so that a location of each said graphical indicator is indicative of growth and value grades of a respective said publically traded financial instrument;
allowing a user to mark at least one area of interest of said multidimensional graphic presentation, said at least one area is indicative of a correlation between a range of value grades and a range of growth grades;
automatically selecting a group of said plurality of publically traded financial instruments based on a respective group of said plurality of graphical indicators depicted within the boundaries of said at least one marked area of interest; and
outputting said selected group.

23. The method of claim 22, wherein generating comprises coloring said plurality of graphical indicators with a plurality of colors each indicative of a different company related characteristic of a common group.

24. The method of claim 23, wherein said company related characteristic is selected from a group consisting of a market capitalization value group, an industrial sector, a trading exchange market, and a country of origin.
